(19) United States
(12) Patent Application Publication
(10) Pub. No.: US 2025/0332578 A1
(43) Pub. Date: Oct. 30, 2025

(54) AMMONIA DECOMPOSITION OVER SUPPORTED MEDIUM ENTROPY METAL ALLOY CATALYSTS

(71) Applicant: Saudi Arabian Oil Company, Dhahran (SA)

(72) Inventors: Xiaoxing Wang, Richmond, TX (US); Feng Liang, Houston, TX (US)

(21) Appl. No.: 18/650,755

(22) Filed: Apr. 30, 2024

(51) Int. Cl. B01J 23/76; B01J 35/45; B01J 37/04; C01B 3/04

(52) U.S. Cl. CPC B01J 23/76; B01J 35/45; B01J 37/04; C01B 3/047; C01B 2203/0277; C01B 2203/1011; C01B 2203/1052; C01B 2203/1082

(57) ABSTRACT

A method of catalytic ammonia decomposition, where the method includes: flowing ammonia into a reactor charged with a supported medium entropy metal alloy (MEA) catalyst including MEA particles supported on a support, the MEA particles including a first principal metal, a second principal metal, and a third principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be; and catalytically decomposing the ammonia into hydrogen and nitrogen over the supported MEA catalyst in the reactor at a reaction temperature between 200° C. and 900° C.

### TECHNICAL FIELD

This document relates to methods of ammonia decomposition over supported medium entropy metal alloy (MEA) catalysts.

### BACKGROUND

Due to concerns over global warming, the need for renewable and clean energy is increasing. Owing to its high weight-based energy density (120 MJ/kg) and no carbon dioxide (CO₂) emissions upon combustion, hydrogen has been regarded as an important part of low carbon energy alternatives. Hydrogen has broad applications in various technologies, including fuel cells, metallurgy, fuel gas and in the chemical industry. The sustainable production of hydrogen has thus received considerable attention.

While hydrogen offers various advantages in renewable and clean energy technologies, hydrogen storage and transport remain a significant challenge. Hydrogen in its gaseous form is the lightest gas and occupies a larger volume per mass compared with traditional fuels. Its liquefaction temperature is very low, about −250° C., thus requiring a significant amount of energy to liquify hydrogen. Alternatively, hydrogen can be transformed into other compounds such as methanol, formic acid, and ammonia in the liquid state for safe and easy storage and transportation. These hydrogen-storing compounds can then be decomposed or reformed to regenerate the stored hydrogen for onsite usage. Therefore, it is important to develop technologies for regenerating hydrogen from such hydrogen-storing compounds. One promising candidate is catalytic ammonia decomposition. However, many catalysts are prone to deactivation by nitrogen species and catalyst particle agglomeration.

### SUMMARY

This disclosure describes the catalytic decomposition of ammonia as a hydrogen-storing compound to generate hydrogen using a supported medium entropy metal alloy (MEA) catalyst. In some embodiments, a method of catalytic ammonia decomposition includes: flowing ammonia into a reactor charged with a supported medium entropy metal alloy (MEA) catalyst including MEA particles supported on a support, where the MEA particles include a first principal metal, a second principal metal, and a third principal metal, and sometimes a fourth principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be; and catalytically decomposing the ammonia into hydrogen and nitrogen over the supported MEA catalyst in the reactor at a reaction temperature between 200° C. and 900° C.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1 is a flow chart of an example method of producing a supported medium entropy metal alloy (MEA) catalyst by ball milling.

FIG. 2A shows an example schematic of a supported MEA catalyst that includes a first principal metal M1, a second principal metal M2, and a third principal metal M3.

FIG. 2B shows an example schematic of a supported MEA catalyst that includes a first principal metal M1, a second principal metal M2, a third principal metal M3 and a fourth principal metal M4.

FIG. 3A shows an example schematic of a supported MEA catalyst with three principal metals that includes a catalyst promoter on a support.

FIG. 3B shows an example schematic of a supported MEA catalyst with four principal metals that includes a catalyst promoter on a support.

FIG. 3C shows an example schematic of a supported MEA catalyst with three principal metals that includes a catalyst promoter in the MEA particles.

FIG. 3D shows an example schematic of a supported MEA catalyst with three principal metals that includes a catalyst promoter both on a support and in the MEA particles.

FIG. 4A shows an example schematic of a supported MEA catalyst with three principal metals that includes defects on a support.

FIG. 4B shows an example schematic of a supported MEA catalyst with four principal metals that includes defects on a support.

FIG. 5A shows an example schematic of a supported MEA catalyst with three principal metals that includes a catalyst promoter and support defects.

FIG. 5B shows an example schematic of a supported MEA catalyst with four principal metals that includes a catalyst promoter and support defects.

FIG. 6 shows an example schematic of a fixed-bed flow reactor system for ammonia decomposition.

FIGS. 7A-7C are flow chart diagrams of process of catalytic ammonia decomposition using a supported MEA catalyst.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure are supported catalysts that include medium entropy alloys (MEA), the synthesis of the supported MEA catalysts, and the use of the supported MEA catalysts for ammonia decomposition to generate hydrogen. In various embodiments, the supported MEA catalysts offer a high conversion and hydrogen yield. Further, the supported MEA catalysts can also be active at lower reaction temperatures, e.g., 400° C.-600° C., as compared to conventional catalysts. Particularly, in some embodiments, the use of a support for MEA catalyst particles suppresses the catalyst deactivation and also ensures particle dispersion with small MEA catalyst particles, e.g., 100 nm or less, on the support.

In general, ammonia has several advantages as a promising hydrogen storage and transportation candidate, including, but not limited to, high hydrogen (H₂) storage capacity, e.g., up to about 17.7 wt %, relatively mild liquefaction conditions, e.g., 8.5 bar at 20° C., a high volumetric energy density, e.g., 108 kg-H₂/m³, its carbon-free nature, and its ability to be massively produced through the Haber-Bosch process. Compared to the methane steam reforming process (Eq. 1), the energy required for the ammonia decomposition process is much lower (Eq. 2), which makes ammonia more economically viable for onsite hydrogen regeneration.

$$\begin{matrix}{CH}_{4} + {H}_{2} O ⇌ CO + 3 {H}_{2} , & {ΔH}_{R}^{∘} = + 68.7 kJ {mol}_{H 2}^{- 1}\end{matrix} \qquad ( Eq . 1 )$$

$$\begin{matrix}2 {NH}_{3} ⇌ {N}_{2} + 3 {H}_{2} , & {ΔH}_{R}^{∘} = + 3 0.6 kJ {mol}_{H 2}^{- 1}\end{matrix} \qquad ( Eq . 2 )$$

Based on thermodynamics, at 300-350° C., the conversion of 96-98% can be reached for ammonia decomposition. However, most catalytic ammonia decomposition (CAD) processes use a higher temperature, e.g., greater than 450° C., for the reaction due to the limitation of reaction kinetics. To conduct NH₃ decomposition at a lower temperature, a catalyst plays an important role by reducing the activation energy and promoting the reaction kinetics. It is reported that the metal activities for CAD processes decrease as follows: Ru>Ni>Rh>Co>Ir>Fe>Pt>Pd>Cu>Te, Se, Pb. The state-of-the-art catalysts for CAD are Ru doped with potassium, barium, and cesium and supported on various oxides and carbon materials. However, due to the high cost of Ru metal, low activity at low temperatures, and rapid deactivation, those catalyst are not economically viable for large-scale and long-term industrial applications. The supported MEA catalysts of this disclosure offer a novel alternative to conventional catalysts for ammonia decomposition with improved catalytic performance.

Further, in various embodiments, the use of support demonstrates additional improvements of the MEA catalysts, for example, by suppressing particle agglomeration and controlling the size of the MEA catalyst particles.

### Supported Medium Entropy Metal Alloy (MEA) Catalyst

Medium entropy metal alloys include three or four principal metals. These alloys have unique properties caused by effects including thermodynamic effects (high entropy), structural effects (crystal lattice distortion), kinetics effects (sluggish diffusion), and cocktail composition effects. Compared to conventional metal alloys, these special effects can significantly influence their catalytic performance for ammonia decomposition, which could reduce the reaction temperature, improve the activity, promote resistance to carbon deactivation and metal sintering/agglomeration, and thus benefit hydrogen production.

MEA are alloys with a configuration entropy between 1R and 1.5R. Configuration entropy can be calculated with the relationship

$$S = - R {\sum }_{i = 1}^{n} {x}_{{M}_{i}} ln ( {x}_{{M}_{i}} ) ,$$

where S is entropy, R is the gas constant, n is the type number of the constitute atoms, and x_{M}_{ᵢ} is the mole fraction of the composition of atom Mᵢ. MEA typically have near equimolar and non-equimolar alloys of three or four principal elements.

The catalysts described herein include one or more MEA catalyst particles. The MEA catalyst particles include three or four principal metals. The MEA catalyst particles of the present disclosure include a first principal metal (M1), a second principal metal (M2), and a third principal metal (M3). In some embodiments, the MEA catalyst particles include a fourth principal metal (M4). The principal metals can be independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. None of M1, M2, or M3 are the same metal. For example, the MEA catalyst particles with three principal metals can be FeMnCo, FeMnNi, FeMnMo, FeMnCu, FeMoCo, FeMoNi, FeMoCu, MnCoNi, MnCoCu, MnCoMo, MnNiCu, MnNiMo, MoCoNi, FeCoCu, FeNiCu, MoCoCu, MoNiCu, or CoNiCu.

For example, the MEA catalyst particles with four principal metals can be FeMnCoNi, FeMnCoCu, FeMnCoMo, FeMnNiMo, FeMnNiCu, FeMnMoCu, FeCoNiMo, FeCoNiCu, FeCoCuMo, CoNiCuMn, CoNiCuMo, MnMoCoNi, MnMoCoCu, or MnMoNiCu.

The content of each principal metal can vary from 1 atomic percent (at %) to 90 at %. In some embodiments, the amount of each principal metal in the MEA catalyst particle can vary from about 1 at % to about 80 at %, from about 1 at % to about 70 at %, from about 1 at % to about 60 at %, from about 1 at % to about 50 at %, from about 1 at % to about 40 at %, from about 1 at % to about 30 at %, from about 1 at % to about 20 at %, from about 1 at % to about 10 at %. In some embodiments, the amount of each principal metal in the MEA catalyst particle can vary from about 10 at % to about 80 at %, from about 10 at % to about 70 at %, from about 10 at % to about 60 at %, from about 10 at % to about 50 at %, from about 10 at % to about 40 at %, from about 10 at % to about 30 at %, or from about 10 at % to about 20 at %.

In some embodiments, each of the principal metals is present in an approximately equimolar amount. In some embodiments with three principal metals, the atomic ratio of M1:M2:M3 is 1:1:1. In some embodiments with four principal metals, the atomic ratio of M1:M2:M3:M4 is 1:1:1:1.

In some embodiments, the atomic percentage of one principal metal element is higher than the other principal metal elements in the MEA catalyst particle. For example, the atomic percentage of one of the principal metal elements is more than 30 atomic % (at %), more than 35%, more than 40 at %, more than 45 at %, more than 50 at %, more than 55 at %, or more than 60 at %. In other embodiments, the atomic ratio among the principal metals can vary as long as the resulting alloy satisfies the configuration entropy between 1R and 1.5R to be an MEA catalyst particle. For example, it is possible the ratio is 1:3:6 for the three-metal alloy system, and 1:1:2:6 for the four-metal alloy system.

In some embodiments, an MEA catalyst particle includes a first principal metal, where the first principal metal is Fe, a second principal metal, where the second principal metal is Mn, and a third principal metal, where the third principal metal is selected from the group consisting of: Co, Cr, Ni, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, an MEA catalyst particle includes a first principal metal, where the first principal metal is Fe, a second principal metal, where the second principal metal is Mn, and a third principal metal, where the third principal metal is a transition metal selected from the group consisting of Co, Cr, Ni, Cu, Zn, Ti, Zr, Mo, V, Ru, Rh, Pd, Ag, W, Re, Ir, Pt, Au, Y, and Sn. In some embodiments, an MEA catalyst particle includes a first principal metal, where the first principal metal is Fe, a second principal metal, where the second principal metal is Mn, and a third principal metal, where the third principal metal is an alkaline earth metal, Be. In some embodiments, an MEA catalyst particle includes a first principal metal, where the first principal metal is Fe, a second principal metal, where the second principal metal is Mn, and a third principal metal, where the third principal metal is a lanthanide selected from the group consisting of Ce and Yb. In some embodiments, an MEA catalyst particle includes a first principal metal, where the first principal metal is Fe, a second principal metal, where the second principal metal is Mn, and a third principal metal, where the third principal metal is selected from the group consisting of Al, Ga and In. In some embodiments, an MEA catalyst particle with three principal metals includes a first principal metal, where the first principal metal is Fe, a second principal metal, where the second principal metal is Mn, and a third principal metal, where the third principal metal is Ni. In some embodiments, an MEA catalyst particle includes Fe, Mn, and Ni in a 1:1:1 atomic ratio.

In some embodiments, an MEA catalyst particle includes a first principal metal, where the first principal metal is Fe, a second principal metal, where the second principal metal is Ni, and a third principal metal, where the third principal metal is selected from the group consisting of: Co, Cr, Mn, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, an MEA catalyst particle includes a first principal metal, where the first principal metal is Fe, a second principal metal, where the second principal metal is Ni, and a third principal metal, where the third principal metal is a transition metal selected from the group consisting of Co, Cr, Mn, Cu, Zn, Ti, Zr, Mo, V, Ru, Rh, Pd, Ag, W, Re, Ir, Pt, Au, Y, and Sn. In some embodiments, an MEA catalyst particle includes a first principal metal, where the first principal metal is Fe, a second principal metal, where the second principal metal is Ni, and a third principal metal, where the third principal metal is an alkaline earth metal, Be. In some embodiments, an MEA catalyst particle includes a first principal metal, where the first principal metal is Fe, a second principal metal, where the second principal metal is Ni, and a third principal metal, where the third principal metal is a lanthanide selected from the group consisting of Ce and Yb. In some embodiments, an MEA catalyst particle includes a first principal metal, where the first principal metal is Fe, a second principal metal, where the second principal metal is Ni, and a third principal metal, where the third principal metal is selected from the group of consisting of Al, Ga and In.

In some embodiments, an MEA catalyst particle includes a first principal metal, where the first principal metal is Fe, a second principal metal, where the second principal metal is Mn, a third principal metal, where the third principal metal is Ni, and a fourth principal metal, where the fourth principal metal is selected from the group consisting of: Co, Cr, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, an MEA catalyst particle includes a first principal metal, where the first principal metal is Fe, a second principal metal, where the second principal metal is Mn, a third principal metal, where the third principal metal is Ni, and a fourth principal metal, where the fourth principal metal is a transition metal selected from the group consisting of Co, Cr, Cu, Zn, Ti, Zr, Mo, V, Ru, Rh, Pd, Ag, W, Re, Ir, Pt, Au, Y, and Sn. In some embodiments, an MEA catalyst particle includes a first principal metal, where the first principal metal is Fe, a second principal metal, where the second principal metal is Mn, a third principal metal, where the third principal metal is Ni, and a fourth principal metal, where the fourth principal metal is an alkaline earth metal, Be. In some embodiments, an MEA catalyst particle includes a first principal metal, where the first principal metal is Fe, a second principal metal, where the second principal metal is Mn, a third principal metal, where the third principal metal is Ni, and a fourth principal metal, where the fourth principal metal is a lanthanide selected from the group consisting of Ce and Yb. In some embodiments, an MEA catalyst particle includes a first principal metal, where the first principal metal is Fe, a second principal metal, where the second principal metal is Mn, a third principal metal, where the third principal metal is Ni, and a fourth principal metal, where the fourth principal metal is Al. In some embodiments, an MEA catalyst particle with four principal metals includes a first principal metal, where the first principal metal is Fe, a second principal metal, where the second principal metal is Mn, a third principal metal, where the third principal metal is Ni, and a fourth principal metal, where the fourth principal metal is Co. In some embodiments, the MEA catalyst particle includes Fe, Mn, Ni, and Co in a 1:1:1:1 atomic ratio.

In some embodiments, the MEA catalyst particles have a configuration entropy between 1R and 1.5R, where R is the gas constant.

Table 1 lists the first (M1), second (M2), and third (M3) principal metals of example MEA catalyst particles that include three principal metals. In some embodiments, the ratio of the principal metals in the MEA catalyst particles listed in Table 1 is 1:1:1. Table 2 lists the first (M1), second (M2), third (M3), and fourth (M4) principal metals of example MEA catalyst particles that include four principal metals. In some embodiments, the ratio of the principal metals in the MEA catalyst particles listed in Table 2 is 1:1:1:1. Tables 1 and 2 are not limiting, and other non-repetitive combinations of the principal metals are possible. All of the MEA particles listed in Table 1 and Table 2 can be combined with support, catalysts promoters, and/or defects as described herein.

TABLE 1
Principal Metals of Example MEA catalyst particles

| M1 | M2 | M3 |
|---|---|---|
| Co | Ni | Cu |
| Fe | Co | Cu |
| Fe | Mn | Be |
| Fe | Mn | Ca |
| Fe | Mn | Ce |
| Fe | Mn | Yb |
| Fe | Mn | Al |
| Fe | Mn | Ag |
| Fe | Mn | Au |
| Fe | Mn | Co |
| Fe | Mn | Cr |
| Fe | Mn | Cu |
| Fe | Mn | Ir |
| Fe | Mn | Mo |
| Fe | Mn | Ni |
| Fe | Mn | Pd |
| Fe | Mn | Pt |
| Fe | Mn | Re |
| Fe | Mn | Rh |
| Fe | Mn | Ru |
| Fe | Mn | Sn |
| Fe | Mn | W |
| Fe | Mn | Zn |
| Fe | Mn | Zr |
| Fe | Mo | Co |
| Fe | Mo | Cu |
| Fe | Mo | Ni |
| Fe | Ni | Be |
| Fe | Ni | Ca |
| Fe | Ni | Ce |
| Fe | Ni | Yb |
| Fe | Ni | Al |
| Fe | Ni | Ag |
| Fe | Ni | Au |
| Fe | Ni | Co |
| Fe | Ni | Cr |
| Fe | Ni | Cu |
| Fe | Ni | Ir |
| Fe | Ni | Mn |
| Fe | Ni | Pd |
| Fe | Ni | Pd |
| Fe | Ni | Pt |
| Fe | Ni | Re |
| Fe | Ni | Rh |
| Fe | Ni | Ru |
| Fe | Ni | Sn |
| Fe | Ni | W |
| Fe | Ni | Zn |
| Fe | Ni | Zr |
| Mn | Co | Cu |
| Mn | Co | Mo |
| Mn | Co | Ni |
| Mn | Ni | Cu |
| Mn | Ni | Mo |
| Mo | Co | Cu |
| Mo | Ni | Cu |

TABLE 2
Principal Metals of Example MEA catalyst particles

| M1 | M2 | M3 | M4 |
|---|---|---|---|
| Co | Ni | Cu | Mn |
| Co | Ni | Cu | Mo |
| Fe | Co | Cu | Mo |
| Fe | Co | Ni | Cu |
| Fe | Co | Ni | Mo |
| Fe | Mn | Ni | Ca |
| Fe | Mn | Ni | Be |
| Fe | Mn | Ni | Ce |
| Fe | Mn | Ni | Yb |
| Fe | Mn | Ni | Al |
| Fe | Mn | Ni | Co |
| Fe | Mn | Ni | Cr |
| Fe | Mn | Ni | Cu |
| Fe | Mn | Ni | Zn |
| Fe | Mn | Ni | Zr |
| Fe | Mn | Ni | Ru |
| Fe | Mn | Ni | Rh |
| Fe | Mn | Ni | Pd |
| Fe | Mn | Ni | Ag |
| Fe | Mn | Ni | W |
| Fe | Mn | Ni | Re |
| Fe | Mn | Ni | Ir |
| Fe | Mn | Ni | Pt |
| Fe | Mn | Ni | Au |
| Fe | Mn | Ni | Sn |
| Fe | Mn | Ni | Mo |
| Fe | Mn | Co | Cu |
| Fe | Mn | Co | Mo |
| Fe | Mn | Mo | Cu |
| Mn | Mo | Co | Cu |
| Mn | Mo | Co | Ni |
| Mn | Mo | Ni | Cu |

The size of the MEA catalyst particle can vary from nanometer scale to micrometer scale in diameter. For example, the MEA catalyst particle can be from about 1 nm to about 10 μm in diameter. In some embodiments, the MEA catalyst particle can be from about 1 nm to about 100 nm, about 1 nm to about 90 nm, about 1 nm to about 80 nm, about 1 nm to about 70 nm, about 1 nm to about 60 nm, about 1 nm to about 50 nm, about 1 nm to about 40 nm, about 1 nm to about 30 nm, about 1 nm to about 20 nm, about 1 nm to about 10 nm, about 1 nm to about 5 nm, or about 1 nm to about 3 nm in diameter. In some embodiments, the MEA catalyst particle can be from about 3 nm to about 100 nm, about 5 nm to about 100 nm, about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 80 nm to about 100 nm, or about 90 nm to about 100 nm, in diameter. The shape of the MEA catalyst particles can be spherical, square/cubic, triangle, or irregular.

A catalyst support can prevent agglomeration and sintering issues for the MEA catalyst particles. Further, with a support, the particle size of MEA particles can be controlled in a suitable manner for hydrogen production. Controlling the amount of metal over the support and variations in the preparation method can control the particle size of MEA particles. A smaller amount of metal will yield a smaller particle. The supported MEA catalysts have high activity for ammonia conversion and good longevity for hydrogen production.

The support in the catalyst system can include metal oxides, mixed oxides, carbon materials or metal organic frameworks (MOFs). The metal oxides can include Al₂O₃, SiO₂, TiO₂, ZrO₂, CeO₂, MgO, or MgAl₂O₃, or any combination thereof. The mixed oxides can include SiO₂—Al₂O₃, ZrO₂—Al₂O₃, CeO₂—Al₂O₃, ZrO₂—TiO₂, CeO₂—TiO₂, ZrO₂—SiO₂, or CeO₂—SiO₂, or any combination thereof. The carbon materials can include amorphous carbon, carbon black, activated carbon, graphene, graphene oxide, carbon nanotubes (CNTs), carbon nanofibers (CNFs), or graphite, or any combination thereof. The type and composition of the catalyst support can influence the formation of MEA particles, e.g., the size, shape, and dimensions of the particles, the alloy-support interaction, sintering resistance, and adsorption of reactants, e.g., ammonia molecules. In various embodiments, the support has unique properties that can potentially benefit the catalyst preparation and catalytic applications. For example, oxides can be stable at high temperatures such as several hundreds of degree Celsius or higher, MOFs can exhibit extremely high surface area up to 3000 m²/g, and carbon materials can also exhibit extremely high surface area, e.g., from 1000 m²/g to 2000 m²/g while being relatively easy to generate defects via thermal and chemical treatment on surface, which can help making the MEA particles smaller, better dispersed, and more stable. Accordingly, in various embodiments, a supported catalyst can remain active and stable during hydrogen production.

In some embodiments, the catalyst system includes an MEA particle and a support, where the MEA particle includes a first, second, and third principal metal, the support includes aluminum oxide (Al₂O₃). In some embodiments, the first, second, and third principal metal and the support are in a 1:1:1:1 molar ratio. In some embodiments, the catalyst system includes an MEA particle and a support, where the MEA particle includes a first, second, third, and fourth principal metal, and the support includes Al₂O₃. In some embodiments, the first, second, third, and fourth principal metal and the support are in a 1:1:1:1:1 molar ratio.

In various embodiments, the total weight of the MEA particles accounts for about 1% to about 90% of the supported MEA catalyst. In some implementations, this loading of MEA particles can be from about 5 wt % to about 70 wt %, e.g., between about 5 wt % and about 60 wt %, about 5 wt % and about 50 wt %, about 5 wt % and about 40 wt %, about 5 wt % and about 30 wt %, about 5 wt % and about 20 wt %, about 5 wt % and about 10 wt %, about 10 wt % and about 70 wt %, about 20 wt % and about 70 wt %, about 30 wt % and about 70 wt %, about 40 wt % and about 70 wt %, about 50 wt % and about 70 wt %, or about 60 wt % and about 70 wt %.

In some embodiments, the catalyst system includes an MEA particle and a support, where the MEA particle includes a first principal metal, where the first principal metal is Fe, a second principal metal, where the second principal metal is Mn, and a third principal metal, where the third principal metal is Ni, and where the support includes Al₂O₃. In some embodiments, the catalyst system includes an MEA particle and support, wherein the MEA particle and support includes Fe, Mn, Ni, and Al₂O₃ in a 1:1:1:1 molar ratio. In some embodiments, the catalyst system includes an MEA particle and a support, where the MEA particle includes a first principal metal, where the first principal metal is Fe, a second principal metal, where the second principal metal is Mn, a third principal metal, where the third principal metal is Ni, and a fourth principal metal, where the fourth principal metal is Co, and where in the support includes Al₂O₃. In some embodiments, the catalyst system includes and MEA particle and support, where the MEA particle and support include Fe, Mn, Ni, Co, and Al₂O₃ in a 1:1:1:1:1 molar ratio.

In some embodiments, the support includes defects. In some embodiments, the defects on the support are created during the synthesis. The defects can include surface atom vacancy, e.g., oxygen vacancy, nitrogen vacancy, carbon vacancy, surface heteroatomic bonding, e.g., nitrogen bonding, oxygen bonding, carbon bonding, structure distortion, surface step, edge defects, stacking fault, or holes, or any combination thereof. The preferred size and dimensions of defects should match the atom size and dimensions of metal atoms loaded over the support, and the concentration of defects should be controlled to the optimized level depending on the type of defects and metal alloys applied.

Defects have a significant impact on the properties of the support material, such as the thermal, optical, magnetic and mechanical properties. Accordingly, the support defects affect catalyst surface adsorption and desorption of reactants and products. Defect engineering is an important and effective strategy to improve catalytic activity of catalysts. The concentrations, distribution, and types of defects often have different influences on the activity of catalysts.

In some embodiments, the MEA catalyst particle includes a promoter. Catalyst promoters can be incorporated into the support by wet impregnation methods, or post-grafting methods. The inclusion of a promoter can change the chemical, physical, and structural properties of the catalyst. The promoters can include a chemical promoter, a structural promoter, or any combination thereof. Chemical promoters change the distribution of electrons in the catalyst and thus improve the activity of the catalyst. Structural promoters alter the structure and physical properties of the catalyst. In addition, structural promoters improve the mechanics and sintering resistance of the catalyst. Further, structural promoters alter the adsorption and chemisorption ability of the active sites for the reactants and products, thus improving the selectivity of the catalyst and enhancing the efficiency and rate of reactions. Suitable promoters include small amounts of molybdenum, calcium, cesium, high melting oxides of some metals, for example, In₂O₃, Cr₂O₃, and rare earth metals. In some embodiments, the MEA catalyst particle can include about 0.5 at % to about 10 at % promoter. For example, the MEA catalyst particle can include about 0.5 at % to about 9 at %, about 0.5 at % to about 8 at %, about 0.5 at % to about 7 at %, about 0.5 at % to about 6 at %, about 0.5 at % to about 5 at %, about 0.5 at % to about 4 at %, about 0.5 at % to about 3 at %, about 0.5 at % to about 2 at %, about 0.5 at % to about 1 at % promoter, about 1 at % to about 10 at %, about 2 at % to about 10 at %, about 3 at % to about 10 at %, about 4 at % to about 10 at %, about 5 at % to about 10 at %, about 6 at % to about 10 at %, about 7 at % to about 10 at %, about 8 at % to about 10 at %, or about 9 at % to about 10 at %.

In some embodiments, the promoters increase the activity of iron-based catalysts. All of the MEA catalyst particles described herein, for example, those listed in Table 1 and Table 2, can include a promoter as described herein.

In some embodiments, a non-reducible metal oxide is added to the MEA catalyst particles and functions as a promoter. The oxide can provide additional surface area and change the interaction between metals, and therefore plays an important role in the catalytic process. The oxide promoter can improve the sintering resistance of alloys, facilitate the adsorption of reactants, and change the carbon growth mechanism. Accordingly, a promoter can improve the activity and stability of an MEA catalyst particle in catalytic hydrogen production.

The non-reducible oxide promoter can include Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, or lanthanide oxides (e.g., La₂O₃, Er₂O₃), or any combination thereof. In some embodiments, the atomic percentage of non-reducible oxides in the MEA catalyst particle is from more than 0 at % to about 20 at %, for example from more than 0 at % to about 20 at %, more than 0 at % to about 19 at %, more than 0 at % to about 18 at %, more than 0 at % to about 17 at %, more than 0 at % to about 17 at %, more than 0 at % to about 16 at %, more than 0 at % to about 15 at %, more than 0 at % to about 14 at %, more than 0 at % to about 13 at %, more than 0 at % to about 12 at %, more than 0 at % to about 11 at %, more than 0 at % to about 10 at %, more than 0 at % to about 9 at %, more than 0 at % to about 8 at %, more than 0 at % to about 7 at %, more than 0 at % to about 6 at %, more than 0 at % to about 5 at %, more than 0 at % to about 4 at %, more than 0 at % to about 3 at %, more than 0 at % to about 2 at %, more than 0 at % to about 1 at %, more than 0 at % to about 0.5 at %, more than 0 at % to about 0.2 at %, about 0.1 at % to about 20 at %, about 0.1 at % to about 19 at %, about 0.1 at % to about 18 at %, about 0.1 at % to about 17 at %, about 0.1 at % to about 17 at %, about 0.1 at % to about 16 at %, about 0.1 at % to about 15 at %, about 0.1 at % to about 14 at %, about 0.1 at % to about 13 at %, about 0.1 at % to about 12 at %, about 0.1 at % to about 11 at %, about 0.1 at % to about 10 at %, about 0.1 at % to about 9 at %, about 0.1 at % to about 8 at %, about 0.1 at % to about 7 at %, about 0.1 at % to about 6 at %, about 0.1 at % to about 5 at %, about 0.1 at % to about 4 at %, about 0.1 at % to about 3 at %, about 0.1 at % to about 2 at %, about 0.1 at % to about 1 at %, about 0.1 at % to about 0.5 at %, about 0.1 at % to about 0.2 at %, about 0.1% to about 20%, about 1 at % to about 20 at %, about 2 at % to about 20 at %, about 3 at % to about 20 at %, about 4 at % to about 20 at %, about 5 at % to about 20 at %, about 6 at % to about 20 at %, about 7 at % to about 20 at %, about 8 at % to about 20 at %, about 9 at % to about 20 at %, about 10 at % to about 20 at %, about 11 at % to about 20 at %, about 11 at % to about 20 at %, about 12 at % to about 20 at %, about 13 at % to about 20 at %, about 14 at % to about 20 at %, about 15 at % to about 20 at %, about 16 at % to about 20 at %, about 17 at % to about 20 at %, about 18 at % to about 20 at %, or about 19 at % to about 20 at %. In some embodiments, the atomic percentage of non-reducible oxides in the MEA catalyst particle is less than 20 at %, for example less than 19 at %, less than 18 at %, less than 17 at %, less than 16 at %, less than 15 at %, less than 14 at %, less than 13 at %, less than 12 at %, less than 11 at %, less than 10 at %, less than 9 at %, less than 8 at %, less than 7 at %, less than 6 at %, less than 5 at %, less than 4 at %, less than 3 at %, less than 2 at %, or less than 1 at %.

In some embodiments, a metal chloride can be incorporated as a promoter into the MEA catalyst particles. At high temperatures, the metal chlorides can activate ammonia molecules to promote the decomposition on the catalyst surface. All of the MEA catalyst particles described herein, for example, those listed in Table 1 and Table 2, can include metal chloride salts as described herein. The metal chlorides can include chlorides of alkali metals, i.e., chlorides of Li, Na, Ca, K, Cs, or Fr, or chlorides of Fe, Co, Mn, Mg, Al, Ni, Mo, Cu, Pd, Pt, Ce, Mg, La, Nd, Ge, or Re, or any combination thereof. For example, the metal chloride can be LiCl, NaCl, KCl, CsCl, FrCl₂, FeCl₃, CoCl₂, CoCl₃, MnCl₂, MnCl₃, MgCl₂, AlCl₃, NiCl₂, MoCl₂, MoCl₃, MoCl₄, MoCl₅, MoCl₆, CuCl, CuCl₂, PdCl₂, PtCl₂, CeCl₃, MgCl₂, LaCl₃, NdCl₃, GeCl₄, ReCl₄, ReCl₅, or ReCl₆, or any combination thereof. In some embodiments, the atomic percentage of the metal chlorides is more than 0 at % to about 20 at %, for example from more than 0 at % to about 20 at %, more than 0 at % to about 19 at %, more than 0 at % to about 18 at %, more than 0 at % to about 17 at %, more than 0 at % to about 17 at %, more than 0 at % to about 16 at %, more than 0 at % to about 15 at %, more than 0 at % to about 14 at %, more than 0 at % to about 13 at %, more than 0 at % to about 12 at %, more than 0 at % to about 11 at %, more than 0 at % to about 10 at %, more than 0 at % to about 9 at %, more than 0 at % to about 8 at %, more than 0 at % to about 7 at %, more than 0 at % to about 6 at %, more than 0 at % to about 5 at %, more than 0 at % to about 4 at %, more than 0 at % to about 3 at %, more than 0 at % to about 2 at %, more than 0 at % to about 1 at %, more than 0 at % to about 0.5 at %, more than 0 at % to about 0.2 at %, about 0.1 at % to about 20 at %, about 0.1 at % to about 19 at %, about 0.1 at % to about 18 at %, about 0.1 at % to about 17 at %, about 0.1 at % to about 17 at %, about 0.1 at % to about 16 at %, about 0.1 at % to about 15 at %, about 0.1 at % to about 14 at %, about 0.1 at % to about 13 at %, about 0.1 at % to about 12 at %, about 0.1 at % to about 11 at %, about 0.1 at % to about 10 at %, about 0.1 at % to about 9 at %, about 0.1 at % to about 8 at %, about 0.1 at % to about 7 at %, about 0.1 at % to about 6 at %, about 0.1 at % to about 5 at %, about 0.1 at % to about 4 at %, about 0.1 at % to about 3 at %, about 0.1 at % to about 2 at %, about 0.1 at % to about 1 at %, about 0.1 at % to about 0.5 at %, about 0.1 at % to about 0.2 at %, about 0.1% to about 20%, about 1 at % to about 20 at %, about 2 at % to about 20 at %, about 3 at % to about 20 at %, about 4 at % to about 20 at %, about 5 at % to about 20 at %, about 6 at % to about 20 at %, about 7 at % to about 20 at %, about 8 at % to about 20 at %, about 9 at % to about 20 at %, about 10 at % to about 20 at %, about 11 at % to about 20 at %, about 11 at % to about 20 at %, about 12 at % to about 20 at %, about 13 at % to about 20 at %, about 14 at % to about 20 at %, about 15 at % to about 20 at %, about 16 at % to about 20 at %, about 17 at % to about 20 at %, about 18 at % to about 20 at %, or about 19 at % to about 20 at %. In some embodiments, the atomic percentage of metal chlorides in the MEA catalyst particle is less than 20 at %, for example less than 19 at %, less than 18 at %, less than 17 at %, less than 16 at %, less than 15 at %, less than 14 at %, less than 13 at %, less than 12 at %, less than 11 at %, less than 10 at %, less than 9 at %, less than 8 at %, less than 7 at %, less than 6 at %, less than 5 at %, less than 4 at %, less than 3 at %, less than 2 at %, or less than 1 at %.

In some embodiments, other compounds which are non-reducible and stable at high temperatures (e.g., stable between 500° C. and 900° C.) can be incorporated as a promoter into the MEA catalyst particles described herein. All of the MEA catalyst particles described herein, for example the MEA catalyst particles listed in Table 1 and Table 2, can include non-reducible and high-temperature-stable compounds as described herein. The non-reducible, stable compounds include carbides, borides, boron carbides, nitrides, boron nitrides, silicide, aluminides, phosphides, phosphates, sulfides, sulfates, hydrides, carbonitrides, (for example, Fe₃C, KBr, NaNO₃, B₄C, BN, Na₄Si₄, Na₂Al₂O₄, FeP, Na₃PO₄, FeS, Na₂SO₄, MgH₂, or C₃N₄) graphene, graphene oxide, carbon nanotubes, graphite, and any combinations thereof. In some embodiments, the atomic percentage of non-reducible and high-temperature-stable compound promoter is more than 0 at % to about 20 at %, for example from more than 0 at % to about 20 at %, more than 0 at % to about 19 at %, more than 0 at % to about 18 at %, more than 0 at % to about 17 at %, more than 0 at % to about 17 at %, more than 0 at % to about 16 at %, more than 0 at % to about 15 at %, more than 0 at % to about 14 at %, more than 0 at % to about 13 at %, more than 0 at % to about 12 at %, more than 0 at % to about 11 at %, more than 0 at % to about 10 at %, more than 0 at % to about 9 at %, more than 0 at % to about 8 at %, more than 0 at % to about 7 at %, more than 0 at % to about 6 at %, more than 0 at % to about 5 at %, more than 0 at % to about 4 at %, more than 0 at % to about 3 at %, more than 0 at % to about 2 at %, more than 0 at % to about 1 at %, more than 0 at % to about 0.5 at %, more than 0 at % to about 0.2 at %, about 0.1 at % to about 20 at %, about 0.1 at % to about 19 at %, about 0.1 at % to about 18 at %, about 0.1 at % to about 17 at %, about 0.1 at % to about 17 at %, about 0.1 at % to about 16 at %, about 0.1 at % to about 15 at %, about 0.1 at % to about 14 at %, about 0.1 at % to about 13 at %, about 0.1 at % to about 12 at %, about 0.1 at % to about 11 at %, about 0.1 at % to about 10 at %, about 0.1 at % to about 9 at %, about 0.1 at % to about 8 at %, about 0.1 at % to about 7 at %, about 0.1 at % to about 6 at %, about 0.1 at % to about 5 at %, about 0.1 at % to about 4 at %, about 0.1 at % to about 3 at %, about 0.1 at % to about 2 at %, about 0.1 at % to about 1 at %, about 0.1 at % to about 0.5 at %, about 0.1 at % to about 0.2 at %, about 0.1% to about 20%, about 1 at % to about 20 at %, about 2 at % to about 20 at %, about 3 at % to about 20 at %, about 4 at % to about 20 at %, about 5 at % to about 20 at %, about 6 at % to about 20 at %, about 7 at % to about 20 at %, about 8 at % to about 20 at %, about 9 at % to about 20 at %, about 10 at % to about 20 at %, about 11 at % to about 20 at %, about 11 at % to about 20 at %, about 12 at % to about 20 at %, about 13 at % to about 20 at %, about 14 at % to about 20 at %, about 15 at % to about 20 at %, about 16 at % to about 20 at %, about 17 at % to about 20 at %, about 18 at % to about 20 at %, or about 19 at % to about 20 at %. In some embodiments, the atomic percentage of non-reducible and high-temperature-stable compound promoter in the MEA catalyst particle is less than 20 at %, for example less than 19 at %, less than 18 at %, less than 17 at %, less than 16 at %, less than 15 at %, less than 14 at %, less than 13 at %, less than 12 at %, less than 11 at %, less than 10 at %, less than 9 at %, less than 8 at %, less than 7 at %, less than 6 at %, less than 5 at %, less than 4 at %, less than 3 at %, less than 2 at %, or less than 1 at %.

In some embodiments, the MEA catalyst particles described herein can include non-reducible oxides, metal chloride salts, and/or other non-reducible and high-temperature-stable compounds. All of the MEA catalyst particles described herein, for example the MEA catalyst particles listed in Table 1 and Table 2, can include non-reducible oxides, metal chloride salts, and/or other non-reducible and high-temperature stable compounds as described herein.

In some embodiments, the catalyst system includes a catalyst particles, support, and promoters. In some embodiments, the catalyst system includes catalyst particles, support, and defects in the support. In some embodiments, the catalyst system includes catalyst particles, support, promoters, and defects in the support. The location of the promotors can be only on the support, in the MEA particles, or both, depending on the preparation method.

### Synthesis and Characterization of Catalysts Including MEA Particles

The supported MEA catalyst particles can be synthesized using wet-chemical methods, for example, impregnation, co-precipitation, solvothermal, or ultrasonicated-assisted wet-chemistry. The supported MEA catalyst particles can by synthesized using sol-gel auto-combustion method, spray pyrolysis, carbothermal shock synthesis, hydrothermal method, pulse-laser ablation, mechanical milling, mechanical alloying, arc melting, induction melting, metal spray technique, molecular beam epitaxy (MBE), atomic layer deposition (ALD), chemical vapor deposition (CVD), or pulsed laser deposition (PLD).

The supported MEA catalyst particles can be synthesized by mechanical mill, for example, ball milling. In a ball milling procedure, an amount of the three principal metals, and optionally a fourth principal metal, are placed in a ball mill along with balls for milling. In some implementations, the balls are zirconia media. For example, the zirconia media can be zirconia particles with a diameter between 0.5 and 10 mm. For example, the zirconia media can include particles with a diameter of 1 mm, or 3 mm. In some embodiments, the ball milling process utilizes more than one size of zirconia media, for example 1 mm and 3 mm media. The ball mill is then rotated at room temperature for a period of time sufficient to produce the catalyst. For example, the ball mill can be rotated for 1-5 days. In some embodiments, the ball mill is rotated for 2 days. The ball mill is rotated at a speed of about 500 to about 2000 rotations per minute (rpm), for example, about 1100 rpm. The resulting MEA powder is then separated from the zirconia media and collected. In some embodiments, the powder is separated from the zirconia media by filtering through a fine mesh screen or a mesh sieve.

In some embodiments, the metal element powders such Fe, Co, Ni, Mn, Cu, Mo, Zn, Ti, Cr, and Al are used as raw materials for alloy synthesis by mechanical mill. A support material, e.g., Al₂O₃ powder, can also be included in the synthesis of a supported catalyst. In one embodiment, 150 g of 3 mm zirconia media, 200 g of 1 mm zirconia media, and the appropriate amount of the three principal metals and the support, e.g., Fe, Co, Mn, and Al₂O₃, at molar ratio of 1:1:1 with total amount of 50 g, are ball milled at room temperature for 2 days at 1100 rpm.

In some embodiments, the MEA catalyst particles can include a non-reducible metal oxide. To synthesize MEA catalyst particles that include a non-reducible metal oxide, the non-reducible metal oxide is placed in the ball mill along with the zirconia media, the three principal metals, and optionally the fourth principal metal, as described herein. The ball mill is then rotated at room temperature for a period of time sufficient to produce the catalyst as described herein. In some embodiments, the MEA catalyst particles can include a metal chloride. To synthesize MEA catalyst particles that include a metal chloride, the metal chloride is placed in the ball mill along with the zirconia media, the three principal metals, and optionally the fourth principal metal, as described herein. The ball mill is then rotated at room temperature for a period of time sufficient to produce the catalyst as described herein.

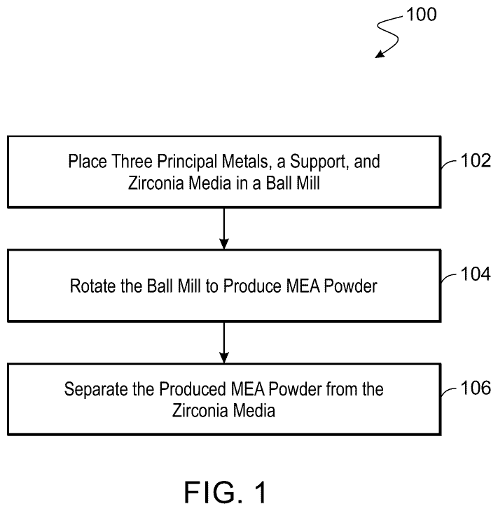

FIG. 1 is a flow chart of an example method 100 of producing a catalyst system of the present disclosure by ball milling. At 102, three principal metals, a support, and zirconia media are placed in a ball mill. In some embodiments, a fourth principal metal is placed in a ball mill. At 104, the ball mill is rotated to produce the catalyst powder. At 106, the produced powder is separated from the zirconia media and collected.

The chemical and physical properties of the synthesized supported MEA catalysts can be investigated with various characterization techniques including X-ray diffraction (XRD), X-ray photoelectron spectroscopy (XPS), scanning electron microscopy (SEM), high-resolution transmission electron microscopy (HRTEM), atomic force microscopy (AFM), energy-dispersive X-ray spectrometry (EDX), BET-surface area, inductively coupled plasma mass spectrometry (ICP-MS), X-ray absorption coefficient, Fourier-transform infrared spectroscopy (FTIR), dynamic light scattering (DLS), UV-vis spectrometry, photoluminescence spectroscopy. In addition, mechanical properties can be analyzed by nanoindentation and dynamical mechanical analysis (e.g., hardness, modulus).

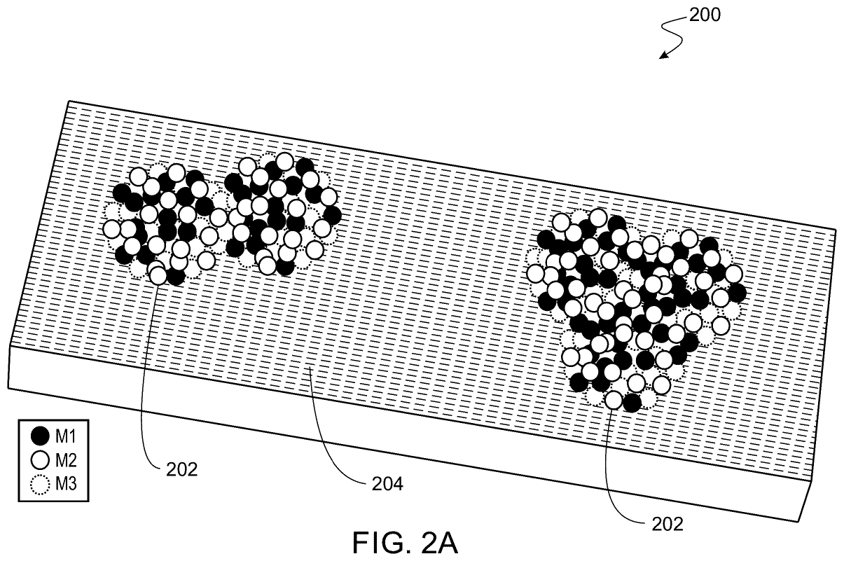

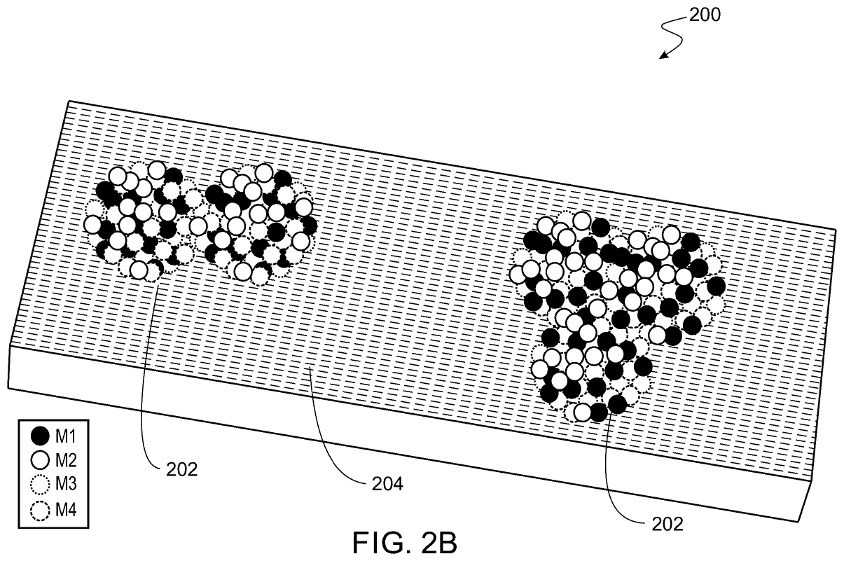

FIGS. 2A-2B show example schematics of a supported MEA catalyst 200 with three or four principal metals. The supported MEA catalyst 200 includes an MEA particle 202 and a support 204. In FIG. 2A, the MEA particle 202 includes three principal metals while it includes four principal metals in FIG. 2B. The support 204 includes metal oxides, mixed oxides, carbon materials or metal organic frameworks (MOFs), as described herein.

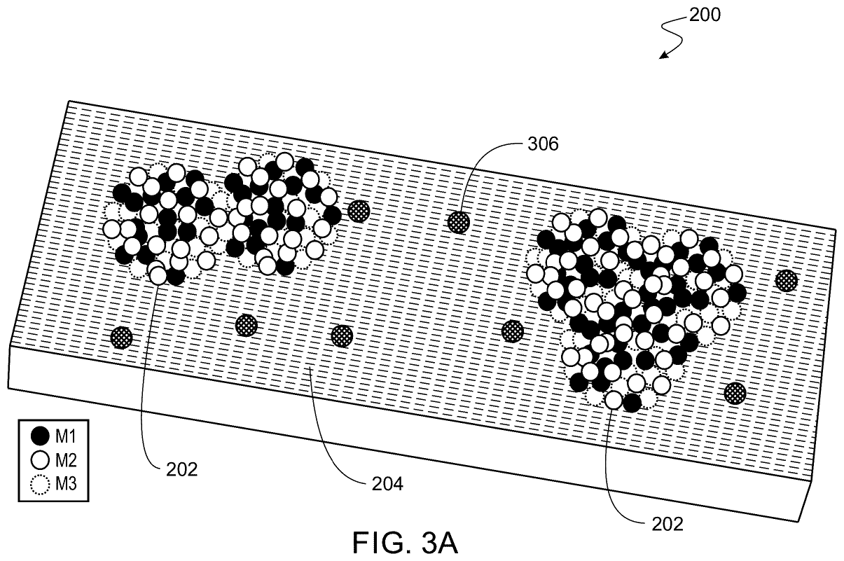

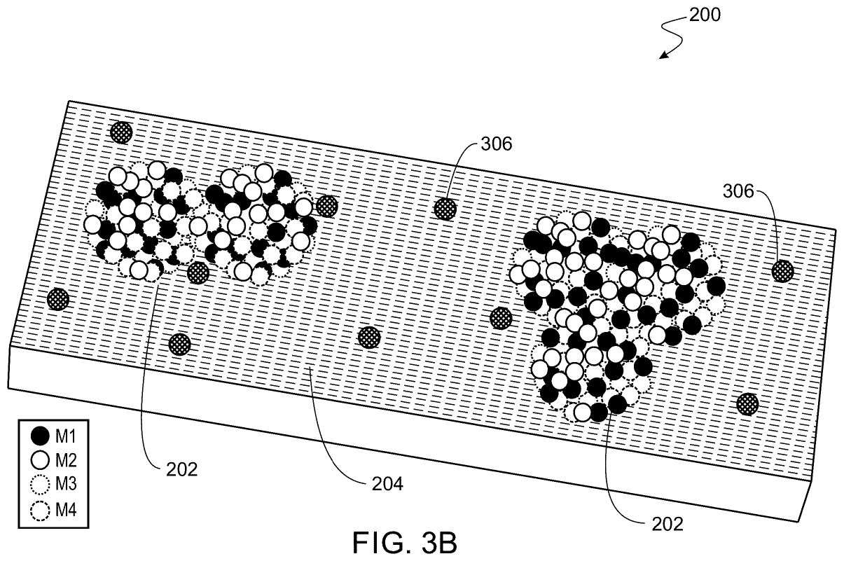

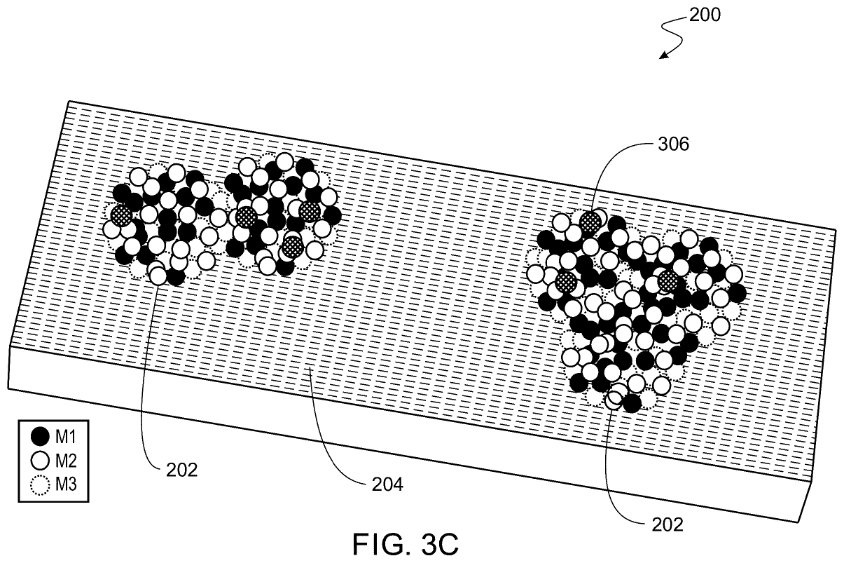

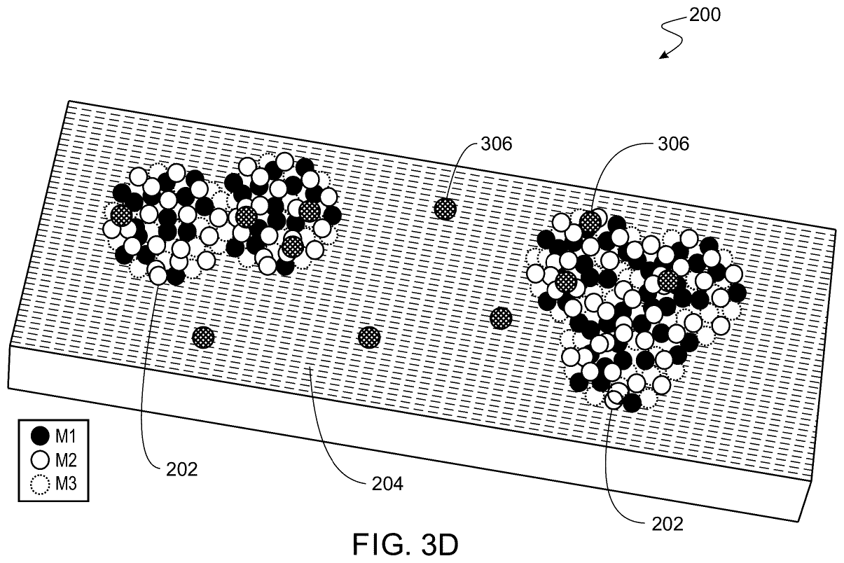

FIGS. 3A-3D show example schematics of a supported catalyst 200, where the MEA catalyst 200 includes an MEA particle 202, a support 204, and a catalyst promoter 306. In FIG. 3A, the MEA particle 202 includes three principal metals while it includes four principal metals in FIG. 3B. FIGS. 3A and 3B both show the embodiments where the promoter 306 is present on the support 204. FIG. 3C show another embodiment where the promoter 306 is incorporated in the MEA particle 202. FIG. 3D show yet another embodiment where the promoter 306 is present on both the support 204 and in the MEA particle 202. The location of the promoter 306 can be tailored by modifying the preparation method.

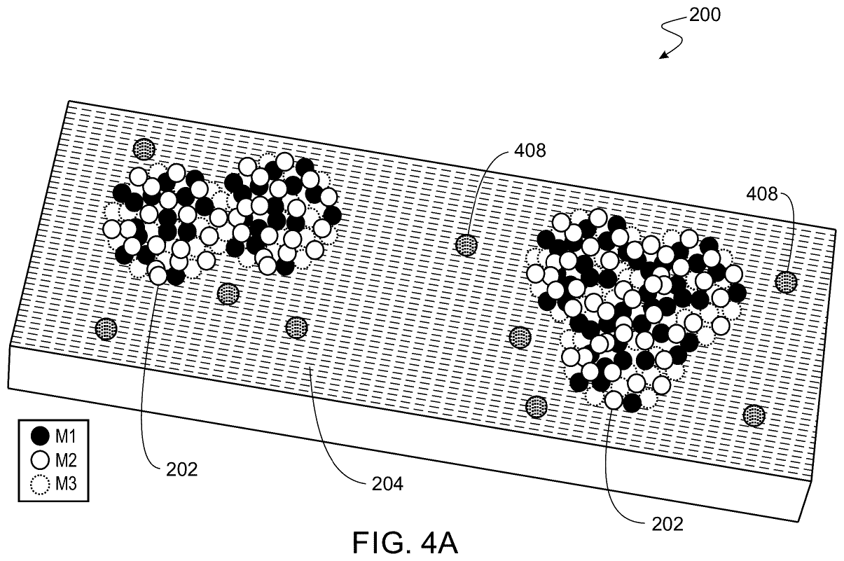

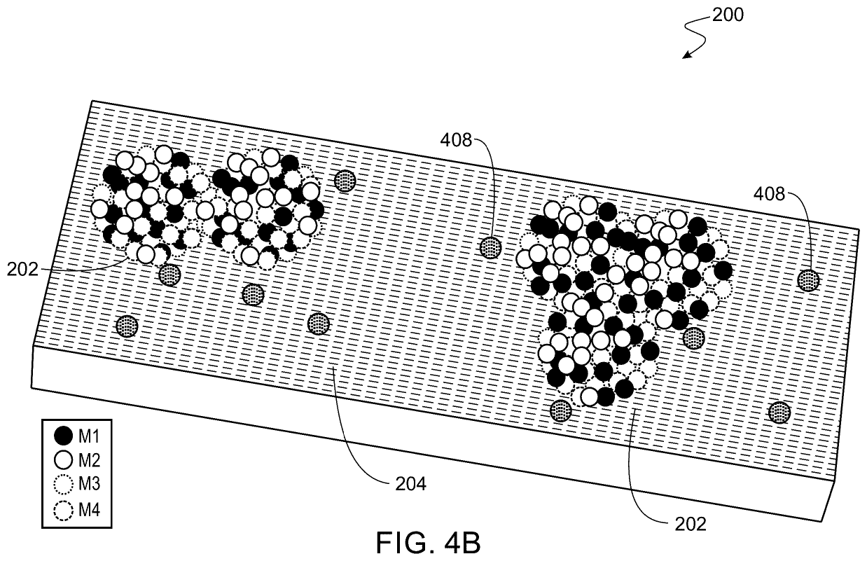

Further, in some embodiments, the catalyst system includes an MEA particle, a support, and defects in the support. FIGS. 4A-4B show example schematics of a supported MEA catalyst 200 with support defects 408. In FIG. 4A, the MEA particle 202 includes three principal metals while it includes four principal metals in FIG. 4B. In some embodiments, oxygen vacancies as support defects can be produced on an activated carbon support. For example, the activated carbon support can be thermally treated at high temperatures, e.g., 300° C. or above, under a gas flow. In some embodiments, the gas flow used for support defects generation can include nitrogen (N₂), steam, CO₂, or a N₂/O₂ mixture, e.g., containing 1-2% O₂. In some embodiments, the thermal treatment can be performed at a temperature from about 300° C. to about 900° C., e.g., from about 400° C. to about 800° C., or from about 500° C. to about 700° C.

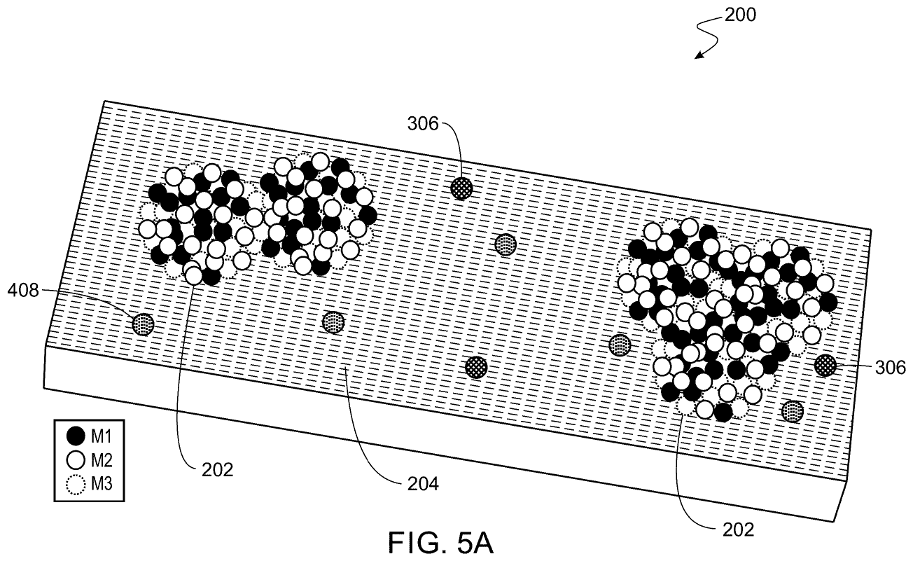

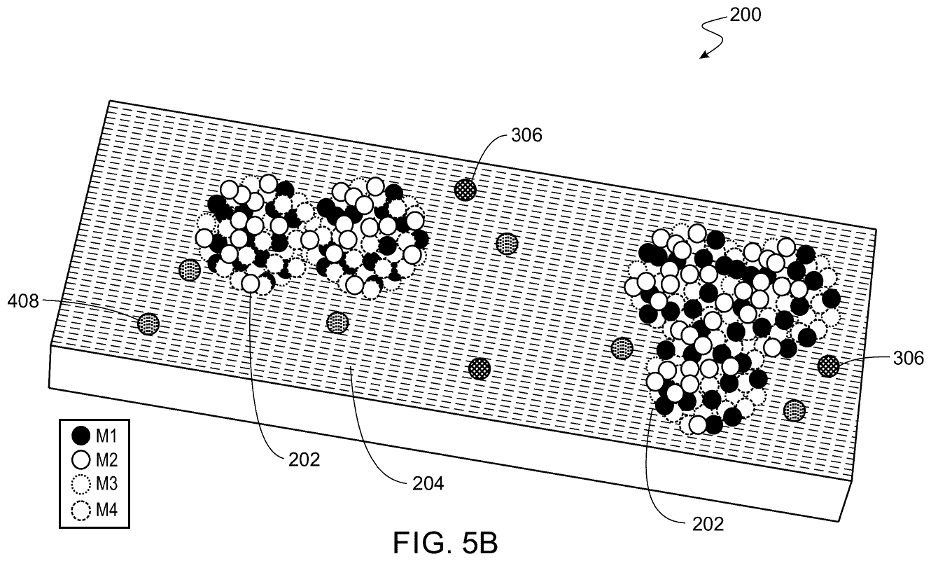

FIGS. 5A-5B show example schematics of a supported MEA catalyst 200 that includes catalyst promoters 306 and defects 408. In FIG. 5A, the MEA particle 202 includes three principal metals while it includes four principal metals in FIG. 5B.

### Catalytic Ammonia Decomposition Over Supported MEA Catalysts for Hydrogen Production

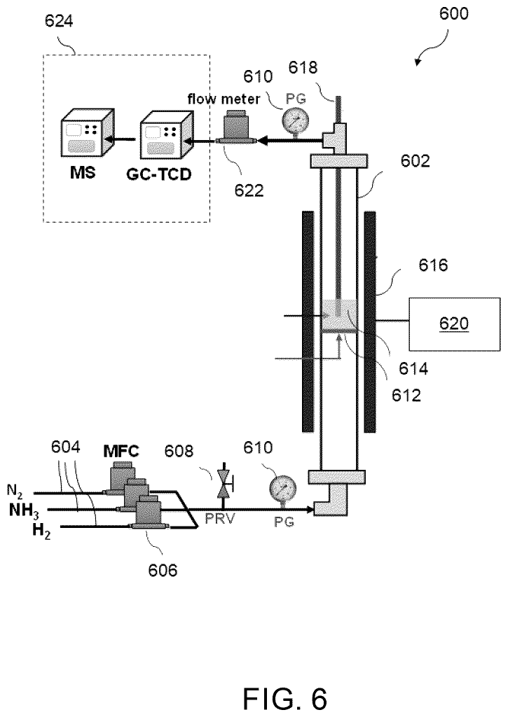

Catalytic ammonia decomposition can be carried out in a fixed-bed reactor system at atmospheric pressure. FIG. 6 shows an example schematic of a fixed-bed flow reactor system 600 having a tubular reactor 602. The tubular reactor 602 is connected to three gas lines 604 to provide various gases to the tubular reactors 602. For example, the gas lines 604 are individually configured to flow a purge gas, e.g., nitrogen (N₂), a catalyst activation gas, e.g., hydrogen (H₂), and a reactant gas, e.g., ammonia (NH₃) as illustrated in FIG. 6. In various embodiments, the flow rate of all three gases to the catalyst bed packed inside the tubular reactor 602 from bottom to top are controlled by a mass flow controller (MFC) 606 individually. For monitoring and controlling the gas flows and pressure of the fixed-bed flow reactor system 600, one or more pressure relief valves 608 and pressure gauges 610 can be used. Further, a frit 612 can be inserted inside the tubular reactor 602 to support a supported MEA catalyst 614. An electric furnace 616 is used to heat the reactor and the reaction temperature is measured by a thermocouple 618 and controlled by controlling the temperature of the furnace using a temperature controller 620. The heating mechanism of the electric furnace 616 can include non-conventional methods such as inductive hearing, microwave heating, plasma heating, and solar panel heating. Some methods of heating can consume less energy and thereby improve the overall energy efficiency of the process. A flow meter 622 is installed to measure the flow rate in the outlet so that the hydrogen production rate and ammonia conversion rate can be recorded and calculated. The gas composition in the outlet can be analyzed by an on-line analytic instrument 624 such as gas chromatography with thermal conductivity detector (GC-TCD), mass spectroscopy, or both. For actual operation for hydrogen production, the process can further include a gas-gas separation and purification unit, e.g., using a hydrogen separation membrane, to obtain the high purity clean hydrogen, 99% purity or greater, for direct hydrogen utilization or storage. The fixed-bed flow reactor system 600 is only for example, and in various embodiments, other appropriate reactor systems can be used for catalytic ammonia decomposition using the supported MEA catalyst.

The catalytic process using the supported MEA catalyst can be performed as follows. First, a supported MEA catalyst as described herein is loaded into the reactor, e.g., the tubular reactor 602 in FIG. 6. Next, the reactor system is purged with an inert gas to remove oxygen in the reactor environment. In some embodiments, the inert gas is nitrogen (N₂) or noble gas. In some embodiments, the inert gas is introduced to the system at a rate of about 20 to about 200 mL/min, for example from for example about 20 to about 200 mL/min, about 30 to about 200 mL/min, about 40 to about 200 mL/min, about 50 to about 200 mL/min, about 60 to about 200 mL/min, about 60 to about 200 mL/min, about 70 to about 200 mL/min, about 80 to about 200 mL/min, about 90 to about 200 mL/min, about 100 to about 200 mL/min, about 110 to about 200 mL/min, about 120 to about 200 mL/min, about 130 to about 200 mL/min, about 140 to about 200 mL/min, about 150 to about 200 mL/min, about 160 to about 200 mL/min, about 170 to about 200 mL/min, about 180 to about 200 mL/min, or about 190 to about 200 mL/min. The applied velocity of the inert gas can depend on the amount of catalyst in the reactor. For example, the applied velocity can be increased for increased amounts of catalyst.

After the purging step, in some embodiments, a catalyst activation step is performed. For example, the catalyst activation includes a reduction treatment of the supported MEA catalyst using a reductive gas such as hydrogen (H₂). In some implementations, the reactor is heated while flowing the inert gas to a catalyst reduction temperature of about 500° C. to about 700° C., for example, about 510° C. to about 700° C., about 520° C. to about 700° C., about 530° C. to about 700° C., about 540° C. to about 700° C., about 550° C. to about 700° C., about 560° C. to about 700° C., about 570° C. to about 700° C., about 580° C. to about 700° C., about 590° C. to about 700° C., about 600° C. to about 700° C., about 610° C. to about 700° C., about 620° C. to about 700° C., about 630° C. to about 700° C., about 640° C. to about 700° C., about 650° C. to about 700° C., about 660° C. to about 700° C., about 670° C. to about 700° C., about 680° C. to about 700° C., about 690° C. to about 700° C., or about 700° C. In some embodiments, the temperature of the reactor is increased at a ramp rate of about 10° C./min to about 15° C./min, for example about 11° C./min to about 15° C., about 12° C./min to about 15° C./min, about 13° C./min to about 15° C./min, about 14° C./min to about 15° C./min, or about 15° C./min. Once the target temperature is reached and stabilized, the gas flow can be switched to the reductive gas, e.g., H₂. In some embodiments, the reductive gas is introduced to the system at a rate of about 20 to about 100 mL/min, for example from for example about 20 to about 100 mL/min, about 30 to about 100 mL/min, about 40 to about 100 mL/min, about 50 to about 100 mL/min, about 60 to about 100 mL/min, about 60 to about 100 mL/min, about 70 to about 100 mL/min, about 80 to about 100 mL/min, or about 90 to about 100 mL/min. The applied velocity of the reductive gas can depend on the amount of catalyst in the reactor. For example, the applied velocity can be increased for increased amounts of catalyst.

After the catalyst activation step, while flowing the reductive gas into the reactor, the temperature of the reactor can be adjusted to a target reaction temperature, e.g., between about 200° C. and about 900° C. at atmospheric pressure. This temperature adjustment can be alternately performed under a flow of the inert gas instead of the reductive gas. In some embodiments, the reaction temperature of 600° C. or lower can be enabled with the active catalyst. A lower reaction temperature can advantageously reduce the required energy input to the process. In some implementations, the reaction temperature for the catalytic ammonia decomposition is between about 400° C. and about 600° C., about 450° C. and about 600° C., about 500° C. and about 600° C., about 550° C. and about 600° C., about 400° C. and about 550° C., about 400° C. and about 500° C., or about 400° C. and about 450° C. In one or more embodiments, the reaction temperature can be at about 400° C. or lower, e.g., between about 200° C. and about 400° C., about 250° C. and about 400° C., about 300° C. and about 400° C., about 350° C. and about 400° C., about 200° C. and about 350° C., about 200° C. and about 300° C., or about 200° C. and about 250° C.

After achieving the target reaction temperature, the reactant gas, e.g., NH₃, is introduced into the reactor. In some embodiments, the reactant gas is introduced into the reactor at a rate of about 5 mL/min to about 200 mL/min, for example about 10 to about 200 mL/min, about 20 to about 200 mL/min, about 30 to about 200 mL/min, about 40 to about 200 mL/min, about 50 to about 200 mL/min, about 60 to about 200 mL/min, about 70 to about 200 mL/min, about 80 to about 200 mL/min, about 90 to about 200 mL/min, about 100 to about 200 mL/min, about 110 to about 200 mL/min, about 120 to about 200 mL/min, about 130 to about 200 mL/min, about 140 to about 200 mL/min, about 150 to about 200 mL/min, about 160 to about 200 mL/min, about 170 to about 200 mL/min, about 180 to about 200 mL/min, or about 190 to about 200 mL/min. In some implementations, the timings of switching the gas flows can be varied. For example, the heating of the reactor for the reduction can be performed after switching the gas flow to the reductive gas.

The product gas containing hydrogen can then be quantified using an online analytical instrument, for example a gas-chromatography with thermal conductive detector (GC-TCD) and the conversion and yield can be calculated accordingly.

In one embodiment, a small amount of the supported MEA catalyst, e.g., a few grams, is loaded into a quartz tube lab reactor. The reactor is then heated to 600° C. at a rate of 5° C. min⁻¹ under a flow of H₂ (20 mL min⁻¹) for 2 h and then purged by nitrogen (N₂) (40 mL min⁻¹) for 1 h. The reactor was cooled down to 200° C. and then reheated to 275° C. under N₂ atmosphere. At 275° C., the gas flow is switched to 5 vol % NH₃ (balanced by N₂). The reaction is carried out at various temperatures by increasing the temperature from 275 to 600° C. stepwise, and steady state is allowed to reach before the product analysis. To determine the conversions of reactant, an on-line mass spectroscopy (MS) and an on-line GC-TCD can be used to analyze NH₃, N₂ and H₂. The NH₃ conversion can be calculated using the formula as below:

$$Conv ( {NH}_{3} ) = \frac{{[ n ( {NH}_{3} ) ]}_{inlet} - {[ n ( {NH}_{3} ) ]}_{outlet}}{{[ n ( {NH}_{3} ) ]}_{inlet}} \times 100 \%$$

where [n(NH₃)]ᵢₙₗₑₜ and [n(NH₃)]ₒᵤₜₗₑₜ refer to the measured moles of NH₃ fed into and flowing out of the reactor.

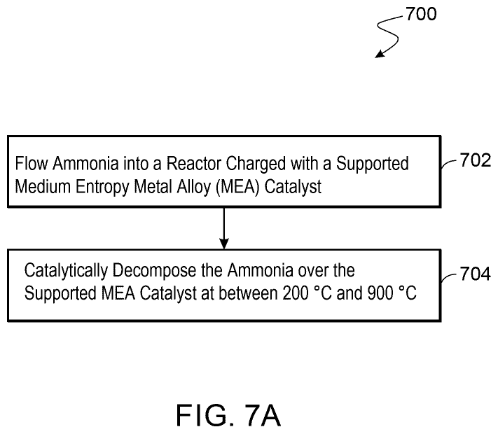

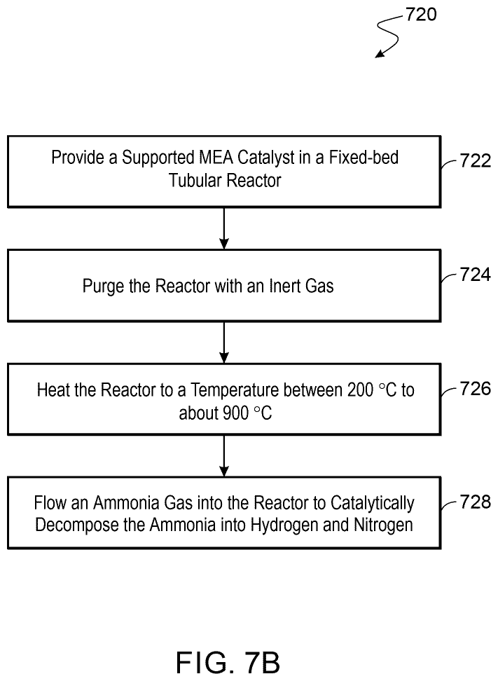

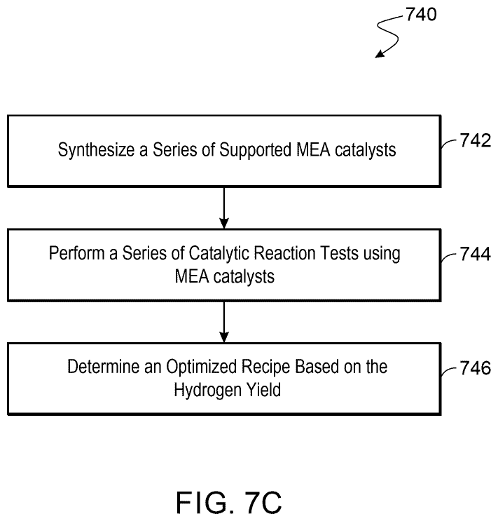

FIGS. 7A-7C are flow chart diagrams of processes of catalytic ammonia decomposition using the supported MEA catalyst in accordance with various embodiments. In accordance with an embodiment, as illustrated in FIG. 7A, a process 700 starts with flowing ammonia 702 into a reactor charged with a supported medium entropy metal alloy (MEA) catalyst. The supported MEA catalyst includes MEA particles supported on a support, where the MEA particles include a first principal metal, a second principal metal, an a third principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be, followed by catalytically decomposing the ammonia 704 into hydrogen and nitrogen over the supported MEA catalyst in the reactor at a reaction temperature between 200° C. and 900° C.

In FIG. 7B, another process 720 starts with providing 722 a supported medium entropy metal alloy (MEA) catalyst in a fixed-bed tubular reactor. The supported MEA catalyst include MEA particles supported on a support, where the MEA particles a first principal metal, a second principal metal, and a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. Further, the support includes a metal oxide, carbon material, or metal organic framework (MOF). Subsequently, the process 720 proceeds to purging 724 the fixed-bed tubular reactor with an inert gas, followed by heating 726 the fixed-bed tubular reactor to a reaction temperature between 200° C. and 900° C. An ammonia gas is then flowed 728 into the fixed-bed tubular reactor to catalytically decompose ammonia into hydrogen and nitrogen over the supported MEA catalyst in the fixed-bed tubular reactor.

In FIG. 7C, yet another process 740 starts with synthesizing 742, according to a series of recipes, a series of supported medium entropy metal alloy (MEA) catalysts. Each supported MEA catalyst includes MEA particles supported on a support, where the MEA particles include a first principal metal, a second principal metal, and a third principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. The recipe contains information about a weight fraction of the support of the supported MEA catalyst. Subsequently, a series of catalytic reaction tests is performed 744 using the series of supported MEA catalysts, where each catalytic reaction test includes decomposing ammonia over one of the series of supported MEA catalysts in a fixed-bed tubular reactor at a reaction temperature of 600° C. or lower, and calculating a hydrogen yield. After the catalytic reaction tests, an optimized recipe is determined 746 from the series of recipes based on a series of the hydrogen yield.

Definitions

The term “about” as used in this disclosure can allow for a degree of variability in a value or range, for example, within 10%, within 5%, or within 1% of a stated value or of a stated limit of a range.

The term “room temperature” as used in this disclosure refers to a temperature of about 15 degrees Celsius (° C.) to about 28° C.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

As used in this disclosure, “atomic percent” (at %) can be considered an atomic fraction or atomic ratio of a substance to the total mixture or composition. Atomic percent can be an atom-to-atom ratio or mole-to-mole ratio, unless indicated otherwise.

A number of embodiments of the disclosure have been described. Nevertheless, it will be understood that various modifications may be made without departing from the spirit and scope of the disclosure.

### Embodiments

1. A method of catalytic ammonia decomposition, where the method includes: flowing ammonia into a reactor charged with a supported medium entropy metal alloy (MEA) catalyst including MEA particles supported on a support, the MEA particles including a first principal metal, a second principal metal, and a third principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be; and catalytically decomposing the ammonia into hydrogen and nitrogen over the supported MEA catalyst in the reactor at a reaction temperature between 200° C. and 900° C.
2. The method of embodiment 1, further including: prior to flowing the ammonia into the reactor, purging the reactor with an inert gas including nitrogen or a noble gas; and after catalytically decomposing the ammonia, separating the hydrogen using a hydrogen separation membrane.
3. The method of embodiment 1 or 2, where the support includes a metal oxide, carbon material, or metal organic framework (MOF).
4. The method of any one of embodiments 1-3, where the support includes a metal oxide selected from the group consisting of Al₂O₃, SiO₂, TiO₂, ZrO₂, CeO₂, MgO, and MgAl₂O₃, and any combination thereof.
5. The method of any one of embodiments 1-4, where the support includes a carbon material selected from the group consisting of amorphous carbon, carbon black, activated carbon, graphene, graphene oxide, carbon nanotubes (CNTs), carbon nanofibers (CNFs), and graphite, and any combination thereof.
6. The method of any one of embodiments 1-5, where the MEA particles are from 1 nm to 10 um in diameter.
7. The method of any one of embodiments 1-6, where a total weight of the MEA particles is from 1% to 90% of the supported MEA catalyst.
8. The method of any one of embodiments 1-7, where a combination of the three principal metals is FeMnCo, FeMnNi, FeMnMo, FeMnCu, FeMoCo, FeMoNi, FeMoCu, MnCoNi, MnCoCu, MnCoMo, MnNiCu, MnNiMo, MoCoNi, FeCoCu, FeNiCu, MoCoCu, MoNiCu, or CoNiCu.
9. The method of any one of embodiments 1-8, where the three principal metals of the MEA particles are equimolar to each other.
10. The method of any one of embodiments 1-9, where the MEA particles further includes a fourth principal metal, where the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.
11. The method of embodiment 10, where a combination of the four principal metals is FeMnCoNi, FeMnCoCu, FeMnCoMo, FeMnNiMo, FeMnNiCu, FeMnMoCu, FeCoNiMo, FeCoNiCu, FeCoCuMo, CoNiCuMn, CoNiCuMo, MnMoCoNi, MnMoCoCu, or MnMoNiCu.
12. The method of embodiment 10, where the four principal metals of the supported MEA catalyst are equimolar to each other.
13. The method of any one of embodiments 1-12, where the supported MEA catalyst further includes a promoter including molybdenum, calcium, cesium, rare earth metal, non-reducible metal oxide, or metal chloride at an atomic percentage (at %) of 0.5 at % to 10 at %.
14. A method of catalytic ammonia decomposition, where the method includes: providing a supported medium entropy metal alloy (MEA) catalyst in a fixed-bed tubular reactor, the supported MEA catalyst including MEA particles supported on a support, the MEA particles including a first principal metal, a second principal metal, and a third principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be, the support including a metal oxide, carbon material, or metal organic framework (MOF); purging the fixed-bed tubular reactor with an inert gas; heating the fixed-bed tubular reactor to a reaction temperature between 200° C. and 900° C.; and flowing an ammonia gas into the fixed-bed tubular reactor to catalytically decompose ammonia into hydrogen and nitrogen over the supported MEA catalyst in the fixed-bed tubular reactor.
15. The method of embodiment 14, further includes, prior to heating the fixed-bed tubular reactor to the reaction temperature, performing a catalyst reduction step including: heating the fixed-bed tubular reactor to a catalyst reduction temperature between 500° C. and 700° C.; and flowing a hydrogen gas into the fixed-bed tubular reactor at the catalyst reduction temperature.
16. The method of embodiment 14 or 15, where the MEA particles include a promoter including molybdenum, calcium, cesium, rare earth metal, non-reducible metal oxide, or metal chloride at an atomic percentage (at %) of 0.5 at % to 10 at %, a total weight of the MEA particles is from 5% to 70% of the supported MEA catalyst, and a combination of the three principal metals is FeMnCo, FeMnNi, FeMnMo, FeMnCu, FeMoCo, FeMoNi, FeMoCu, MnCoNi, MnCoCu, MnCoMo, MnNiCu, MnNiMo, MoCoNi, FeCoCu, FeNiCu, MoCoCu, MoNiCu, or CoNiCu.
17. A method of developing an ammonia decomposition catalyst, where the method includes: synthesizing, according to a series of recipes, a series of supported medium entropy metal alloy (MEA) catalysts, each supported MEA catalyst including MEA particles supported on a support, the MEA particles including a first principal metal, a second principal metal, and a third principal metal, where each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be, and where each recipe contains information about a weight fraction of the support of the supported MEA catalyst; performing a series of catalytic reaction tests using the series of supported MEA catalysts, each catalytic reaction test including decomposing ammonia over one of the series of supported MEA catalysts in a fixed-bed tubular reactor at a reaction temperature of 600° C. or lower, and calculating a hydrogen yield; and determining an optimized recipe from the series of recipes based on a series of the hydrogen yield.
18. The method of embodiment 17, where the first principal metal is Fe and the second principal metal is Mn, Co, or Ni.
19. The method of embodiment 17 or 18, where the recipe includes adding a promoter to the supported MEA catalyst, and where the promoter includes molybdenum, calcium, cesium, rare earth metal, non-reducible metal oxide, or metal chloride at an atomic percentage (at %) of 0.5 at % to 10 at %.
20. The method of any one of embodiments 17-19, where the recipe includes: placing the first principal metal, the second principal metal, and the third principal metal, the support, and zirconia media in a ball mill; rotating the ball mill to produce a power mixture; and separating the supported MEA catalyst from the zirconia media.

What is claimed is:

1. A method of catalytic ammonia decomposition, the method comprising:
flowing ammonia into a reactor charged with a supported medium entropy metal alloy (MEA) catalyst comprising MEA particles supported on a support, the MEA particles comprising
a first principal metal,
a second principal metal, and
a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be; and
catalytically decomposing the ammonia into hydrogen and nitrogen over the supported MEA catalyst in the reactor at a reaction temperature between 200° C. and 900° C.

2. The method of claim 1, further comprising:
prior to flowing the ammonia into the reactor, purging the reactor with an inert gas comprising nitrogen or a noble gas; and
after catalytically decomposing the ammonia, separating the hydrogen using a hydrogen separation membrane.

3. The method of claim 1, wherein the support comprises a metal oxide, carbon material, or metal organic framework (MOF).

4. The method of claim 1, wherein the support comprises a metal oxide selected from the group consisting of Al₂O₃, SiO₂, TiO₂, ZrO₂, CeO₂, MgO, and MgAl₂O₃, and any combination thereof.

5. The method of claim 1, wherein the support comprises a carbon material selected from the group consisting of amorphous carbon, carbon black, activated carbon, graphene, graphene oxide, carbon nanotubes (CNTs), carbon nanofibers (CNFs), and graphite, and any combination thereof.

6. The method of claim 1, where the MEA particles are from 1 nm to 10 μm in diameter.

7. The method of claim 1, wherein a total weight of the MEA particles is from 1% to 90% of the supported MEA catalyst.

8. The method of claim 1, wherein a combination of the three principal metals is FeMnCo, FeMnNi, FeMnMo, FeMnCu, FeMoCo, FeMoNi, FeMoCu, MnCoNi, MnCoCu, MnCoMo, MnNiCu, MnNiMo, MoCoNi, FeCoCu, FeNiCu, MoCoCu, MoNiCu, or CoNiCu.

9. The method of claim 1, wherein the three principal metals of the MEA particles are equimolar to each other.

10. The method of claim 1, wherein the MEA particles further comprises a fourth principal metal, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.

11. The method of claim 10, wherein a combination of the four principal metals is FeMnCoNi, FeMnCoCu, FeMnCoMo, FeMnNiMo, FeMnNiCu, FeMnMoCu, FeCoNiMo, FeCoNiCu, FeCoCuMo, CoNiCuMn, CoNiCuMo, MnMoCoNi, MnMoCoCu, or MnMoNiCu.

12. The method of claim 10, wherein the four principal metals of the supported MEA catalyst are equimolar to each other.

13. The method of claim 1, wherein the supported MEA catalyst further comprises a promoter comprising molybdenum, calcium, cesium, rare earth metal, non-reducible metal oxide, or metal chloride at an atomic percentage (at %) of 0.5 at % to 10 at %.

14. A method of catalytic ammonia decomposition, the method comprising:
providing a supported medium entropy metal alloy (MEA) catalyst in a fixed-bed tubular reactor, the supported MEA catalyst comprising MEA particles supported on a support, the MEA particles comprising
a first principal metal,
a second principal metal, and
a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be, the support comprising a metal oxide, carbon material, or metal organic framework (MOF);
purging the fixed-bed tubular reactor with an inert gas;
heating the fixed-bed tubular reactor to a reaction temperature between 200° C. and 900° C.; and
flowing an ammonia gas into the fixed-bed tubular reactor to catalytically decompose ammonia into hydrogen and nitrogen over the supported MEA catalyst in the fixed-bed tubular reactor.

15. The method of claim 14, further comprising, prior to heating the fixed-bed tubular reactor to the reaction temperature, performing a catalyst reduction step comprising:
heating the fixed-bed tubular reactor to a catalyst reduction temperature between 500° C. and 700° C.; and
flowing a hydrogen gas into the fixed-bed tubular reactor at the catalyst reduction temperature.

16. The method of claim 14, wherein
the MEA particles comprise a promoter comprising molybdenum, calcium, cesium, rare earth metal, non-reducible metal oxide, or metal chloride at an atomic percentage (at %) of 0.5 at % to 10 at %,
a total weight of the MEA particles is from 5% to 70% of the supported MEA catalyst, and
a combination of the three principal metals is FeMnCo, FeMnNi, FeMnMo, FeMnCu, FeMoCo, FeMoNi, FeMoCu, MnCoNi, MnCoCu, MnCoMo, MnNiCu, MnNiMo, MoCoNi, FeCoCu, FeNiCu, MoCoCu, MoNiCu, or CoNiCu.

17. A method of developing an ammonia decomposition catalyst, the method comprising:
synthesizing, according to a series of recipes, a series of supported medium entropy metal alloy (MEA) catalysts, each supported MEA catalyst comprising MEA particles supported on a support, the MEA particles comprising
a first principal metal,
a second principal metal, and
a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be, and wherein each recipe contains information about a weight fraction of the support of the supported MEA catalyst;
performing a series of catalytic reaction tests using the series of supported MEA catalysts, each catalytic reaction test comprising
decomposing ammonia over one of the series of supported MEA catalysts in a fixed-bed tubular reactor at a reaction temperature of 600° C. or lower, and
calculating a hydrogen yield; and
determining an optimized recipe from the series of recipes based on a series of the hydrogen yield.

18. The method of claim 17, wherein the first principal metal is Fe and the second principal metal is Mn, Co, or Ni.

19. The method of claim 17, wherein the recipe comprises adding a promoter to the supported MEA catalyst, and wherein the promoter comprises molybdenum, calcium, cesium, rare earth metal, non-reducible metal oxide, or metal chloride at an atomic percentage (at %) of 0.5 at % to 10 at %.

20. The method of claim 17, wherein the recipe comprises:
placing the first principal metal, the second principal metal, and the third principal metal, the support, and zirconia media in a ball mill;
rotating the ball mill to produce a power mixture; and
separating the supported MEA catalyst from the zirconia media.
